(19) United States
(12) Patent Application Publication
(10) Pub. No.: US 2006/0012317 A1
(43) Pub. Date: Jan. 19, 2006

(54) RF remote dimmer controller

(76) Inventors: Shin-Yung Chiu, Sindian City (TW); Tse-Hung Lin, Jhonghe City (TW)

Correspondence Address: BACON & THOMAS, PLLC, 625 SLATERS LANE, FOURTH FLOOR, ALEXANDRIA, VA, 22314, US

(21) Appl. No.: 10/890,133

(22) Filed: Jul. 14, 2004

(51) Int. Cl. G05F 1/00

(52) U.S. Cl. 315/294

(57) ABSTRACT

This invention discloses a RF remote dimmer controller that comprises a wireless transmitter, a receiver, a microcontroller, an optical coupler, a phase control microcontroller and a power driver; wherein after the transmitter transmits a radio frequency (RF) signal, the signal is received by the receiver and then identified and decoded by the microcontroller; and the microcontroller transmits the control signal to the input end of an optical coupler and drives the output end of the optical coupler to receive the light signal activating the input end in order to output the corresponding control signal to the input end of a phase control microcontroller and activate to output the corresponding control signal to the input end of the phase control microcontroller; while a CTC timer of the phase control microcontroller is used to compute the pulse wave width of the control signal inputted from the optical coupler to control the phase of the corresponding conduction angle of the power driver according to the pulse wave width of the inputted signal in order to change the phase of the conduction angle of the lamp and achieve the effect of controlling and adjusting the brightness of a lamp at a remote end.

### BACKGROUND OF THE PRESENT INVENTION

1. Field of the Present Invention

The present invention relates to a remote dimmer controller, more particularly to a RF remote dimmer controller for controlling the brightness of a lamp.

2. Description of Prior Act

At present, most of the traditional dimmer circuits used for lamps adopt a TRIAC together with a phase-controlled circuit and a variable resistor to change the conduction angle of a lamp and thus achieve the purpose of controlling and adjusting the brightness of a lamp.

However, such prior-art dimmer circuits are manual circuits that require users to manually operate the dimmer switch on the lamp to control the variable resistor of the dimmer circuit and adjust the brightness of the lamp.

Therefore, it is very useful to users if there is a remote dimmer controller that uses a wireless signal to control the brightness of a lamp.

### SUMMARY OF THE PRESENT INVENTION

It is therefore a primary objective of the present invention to provide a RF remote dimmer controller that comprises a wireless transmitter and a remote dimmer control circuit; wherein the remote dimmer control circuit is used in a general lamp, and allows users to control the wireless transmitter to adjust the brightness of a lamp from a remote end.

The second objective of the present invention is to provide a remote dimmer control circuit that comprises a wireless transmitter and a remote control dimmer circuit; wherein the remote control dimmer circuit comprises a receiver, a microcontroller, an optical coupler, a phase control microcontroller and a power driver. When a user controls the transmitter to transmit a radio frequency signal, the signal is received by the remote control dimmer circuit and then identified and decoded by the microcontroller. A corresponding control signal is transmitted from a corresponding transmitter to the input end of an optical coupler and drives the output end of the optical coupler to receive the light signal activation at the input end in order to output the corresponding control signal to the input end of a phase control microcontroller. A CTC timer of the phase control microcontroller is used to compute the pulse wave width of the control signal inputted from the optical coupler to control the phase of the corresponding conduction angle of the power driver according to the pulse wave width of the inputted signal in order to change the phase of the conduction angle of the lamp and achieve the effect of controlling and adjusting the brightness of a lamp at a remote end.

### BRIEF DESCRIPTION OF THE DRAWING FIGURES

FIG. 1 is a schematic circuit diagram of the remote dimmer controller according to the present invention for depicting the relation between components and the position of each component.

FIG. 2 is an illustrative view of the remote dimmer controller with its remote dimmer control circuit being installed inside a lamp such as a floor lamp according to the present invention.

FIG. 3 is an illustrative view of the remote dimmer controller with its remote dimmer control circuit being installed outside a lamp such as a ceiling lamp according to the present invention.

### DETAILED DESCRIPTION OF THE PREFERRED EMBODIMENTS

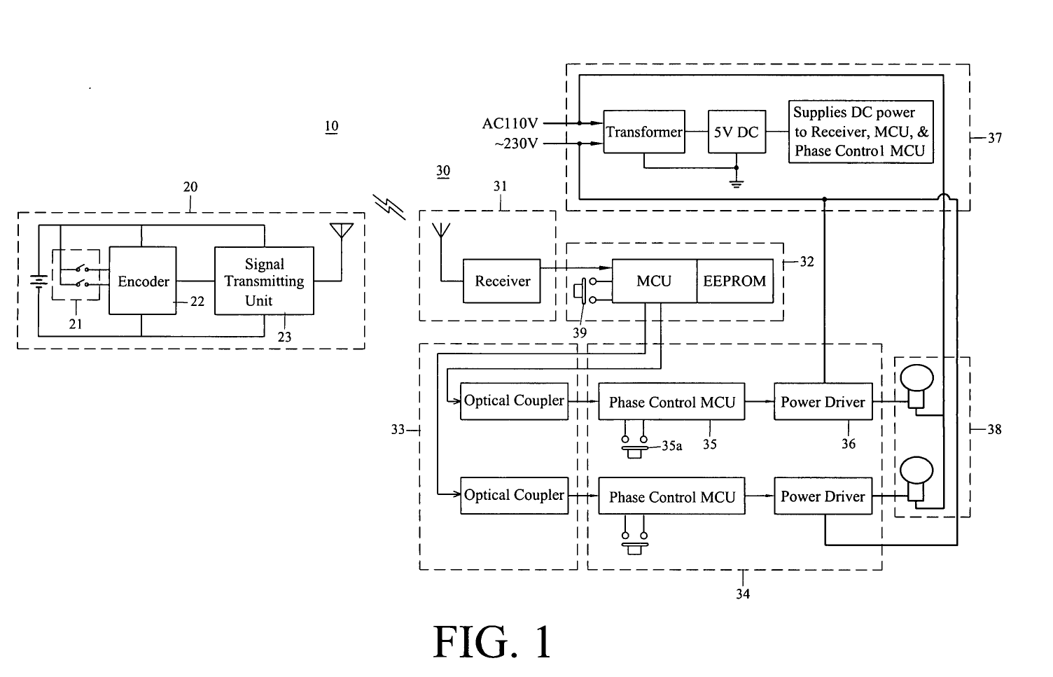

Referring to FIGS. 1 to 3, a preferred embodiment of remote dimmer controller 10 of the present invention comprises a wireless transmitter 20 and a remote dimmer control circuit 30; wherein the remote dimmer control circuit 30 may be installed inside or outside the base of a general lamp 40 such as a floor lamp or an illumination lamp, and users can use a press button 21 on the wireless transmitter 20 to adjust the brightness of every light bulb 38 of the lamp 40.

The wireless transmitter 20 comprises a plurality of press buttons 21, an encoder 22 and a signal transmitting unit 23. When a user presses the press button 21 of the transmitter 20, the press button 21 is to control the encoder 22 of the wireless transmitter 20 to generate an identification code with corresponding radio frequency RF signal information, and transmits the identification code and the RF signal from the signal transmitting unit 23 by surface acoustic waves SAW.

Therefore, the wireless transmitter 20 capable of sending out the RF control signal comprises a Power On/Off signal, a desired lamp 40 dimmer target signal, a desired independent bulb 38 dimmer target signal and a lamp dimmer signal etc.

The remote dimmer control circuit 30 comprises a receiver 31, a microcontroller (MCU) 32, an optical coupler module 33, a phase control module 34 and a power circuit 37. Besides supplying the alternate current power for the light bulb 38, the power circuit 37 also supplies the power required by the receiver 81, the microcontroller (MCU) 32, and the phase control module 34 after a transformer converts the alternate current into a 5V direct current.

The function of the receiver 31 is to receive the identification code and the RF signal transmitted from the wireless transmitter 20 and send the received identification code and RF signal to the input port of the microcontroller (MCU) 32.

The microcontroller (MCU) 32 is an IC component that independently carries out specific control functions and integrates the related circuits for the central processing unit (CPU), read-on memory (ROM), electrically erasable programmable read-on memory (EEPROM), random access memory, I/O control circuit and CTC timer on a single chip.

Since the ROM or EEPROM of the microcontroller (MCU) 32 contains the information of the identification code and the RF signal of the corresponding decoding, therefore after the identification code received by the receiver is confirmed, the microcontroller (MCU) 32 will input the corresponding RF signal and the corresponding decoded control signal, and then output these signals from the output port of the microcontroller (MCU) 32 to the input port of the optical coupler module 33.

In the meantime, the microcontroller (MCU) 32 can add a learning circuit with a learning function, so that if the original wireless transmitter 20 is missing or lost, then the identification code can be inputted for a new wireless transmitter 20 to replace the original wireless transmitter 20.

The optical coupler module 33 comprises an optical coupler 33a, and each optical coupler 33a is coupled to different output ports of the microcontroller (MCU) 32. Therefore, the microcontroller (MCU) 32 can carry out the multitasking function while simultaneously controlling the working sequence of every optical coupler 33a of the optical coupler module 33 and transmitting the corresponding control signals individually.

After the input port of every optical coupler 33a has received the control signal transmitted from the microcontroller (MCU) 32, an optical signal is initialized to drive the output port of the optical coupler 33a to output the corresponding control signal to a phase control module 34 after the output port has received the optical signal.

Further, the optical coupler 33a has an insulating property and is connected between a low-voltage microcontroller (MCU) 32 and a high-voltage power driver 36 for disconnecting the circuits of the microcontroller (MCU) 32 and the phase control module 34 with the high voltage of the power circuit 37 to protect the microcontroller (MCU) 32 and the phase control module 34.

The phase control module 34 comprises a group of phase control microcontrollers (MCU) 35 and power driver 36 connected in a series and the input port of each phase control microcontroller (MCU) 35 is connected with the output port of each corresponding optical coupler 33a. Therefore, the control signal outputted from each optical coupler 33a can be transmitted to the input port of the corresponding phase control microcontroller (MCU) 35.

Each phase control microcontroller (MCU) 35 is an independent IC component for carrying out specific control functions, more particularly for computing the pulse wave width of the control signal inputted by the optical coupler 33a by a CTC timer, and controlling the corresponding conduction angle of each power driver 36 according to the pulse wave width of the inputted control signal.

In the meantime, each phase control microcontroller (MCU) 35 can add a manual button for manually setting the phase of a conduction angle, such that the remote dimmer controller according to the present invention can have such function.

Each power driver 36 is composed of AC silicon control transistors (TRIAC) and is connected to the output port of the phase control microcontroller (MCU) 35 in a series for connecting the gate of the TRIAC, and the other two poles of each TRIAC are connected individually to the light bulb 38 and the fire wire.

Therefore, the time for a user to press the press button 21 of the wireless transmitter 20 can be used to control the pulse wave width of different control signals corresponding to different outputs for the phase control microcontroller (MCU) 35 and produce different gate currents for different timing for the gates of the TRIAC and further change and control the phase of the conduction angle of the TRIAC, so that the light bulb 38 can change the brightness of the lamp according to the phase of the conduction angle.

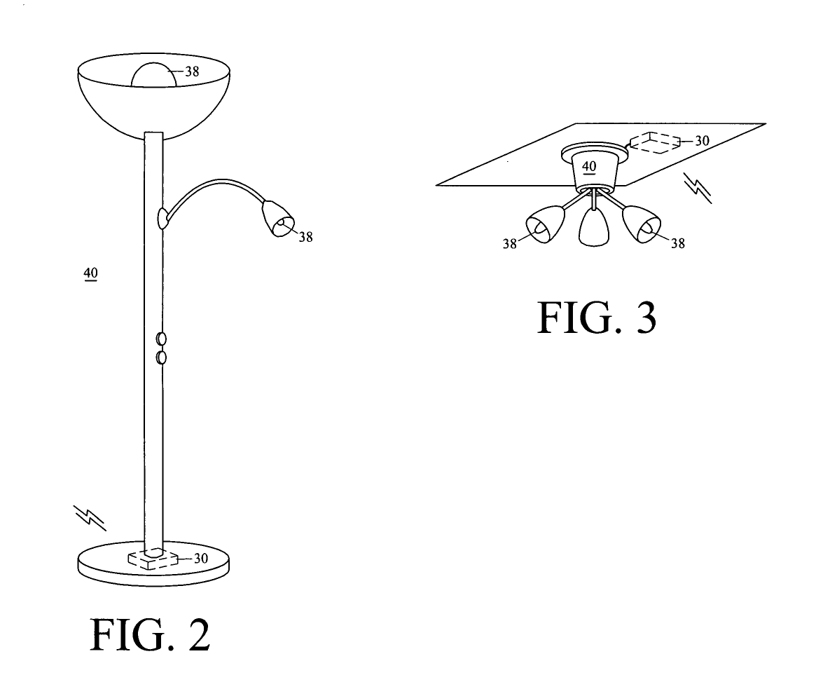

The remote dimmer control circuit 30 of the present invention as shown in FIGS. 2 and 3 is installed inside or outside a general lamp 40 such as a floor lamp or an illumination lamp to let users use a wireless transmitter 20 to adjust the brightness of each light bulb 38 of the lamp 40.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A remote dimmer controller, comprising a wireless transmitter and a remote dimmer control circuit; wherein said wireless transmitter transmits a RF signal for dimming a light and said remote dimmer control circuit comprising:
a receiver, for receiving said RF signal transmitted from said wireless transmitter;
a microcontroller (MCU), for identifying and decoding said RF signal received by said receiver and output said RF signal to an input port of An optical coupler;
an optical coupler module, comprising at least one optical coupler, and an input port of said each optical coupler initializes an optical signal after receiving said signal and outputting said signal through an output port; and
a phase control module, for computing a pulse wave width of an input signal and controlling the phase of a conduction angle of a light bulb according to the pulse wave width of said input signal.

2. The remote dimmer controller of claim 1, wherein said phase control module comprises at least one group of phase control microcontroller (MCU) and an alternate current silicon control transistor TRIAC connected in a series, and said phase control microcontroller is capable of computing a pulse wave width of said input signal and driving said TRIAC to change the phase of a conduction angle for said light bulb according to the pulse wave width of said input signal.

3. The remote dimmer controller of claims 1, wherein said microcontroller (MCU) is capable of memorizing said identification code transmitted from said wireless transmitter.

4. The remote dimmer controller of claims 2, wherein said microcontroller (MCU) is capable of memorizing said identification code transmitted from said wireless transmitter.

5. The remote dimmer controller of claims 1, wherein in said phase control microcontroller (MCU) is capable of manually setting the phase of said conduction angle.

6. The remote dimmer controller of claims 2, wherein in said phase control microcontroller (MCU) is capable of manually setting the phase of said conduction angle.

7. The remote dimmer controller of claims 1, wherein in said remote dimmer control circuit is disposed selectively inside or outside a base of said lamp.

8. The remote dimmer controller of claims 2, wherein in said remote dimmer control circuit is disposed selectively inside or outside a base of said lamp.

9. The remote dimmer controller of claim 3, wherein in said remote dimmer control circuit is disposed selectively inside or outside a base of said lamp.

10. The remote dimmer controller of claim 4, wherein in said remote dimmer control circuit is disposed selectively inside or outside a base of said lamp.

11. The remote dimmer controller of claim 5, wherein in said remote dimmer control circuit is disposed selectively inside or outside a base of said lamp.

12. The remote dimmer controller of claim 6, wherein in said remote dimmer control circuit is disposed selectively inside or outside a base of said lamp.
